(19) United States
(12) Patent Application Publication
(10) Pub. No.: US 2026/0291911 A1
(43) Pub. Date: Sep. 24, 2026

(54) TEMPORARY HOSTNAME RELAY FOR CLIENT-HOST CONNECTIVITY

(71) Applicant: NETFLIX, INC., Los Gatos, CA (US)

(72) Inventor: Olivier Jean POITREY, Le Chesnay (FR)

(21) Appl. No.: 19/421,477

(22) Filed: Dec. 16, 2025

Related U.S. Application Data
(60) Provisional application No. 63/774,919, filed on Mar. 20, 2025.

(51) Int. Cl. H04L 61/4511; H04L 9/40; H04L 61/3015; G06K 19/06

(52) U.S. Cl. CPC H04L 61/4511; H04L 61/3025; H04L 63/166; G06K 19/06037

(57) ABSTRACT

A method and system are disclosed for establishing communication between a local server computing device and one or more client computing devices through a relay module. The local server computing device establishes an initial server connection with the relay module and receives a temporary hostname. The temporary hostname is provided to a client computing device. The client computing device establishes a connection with the relay module using the temporary hostname. The relay module generates relay connection information linking the client connection to the initial server connection. A spliced connection is generated based on the relay connection information, thereby enabling bidirectional communication between the local server computing device and the client computing device. The temporary hostname and the relay connection information are invalidated upon termination of the initial server connection.

### CROSS-REFERENCE TO RELATED APPLICATIONS

The present application claims the benefit of U.S. Provisional Application titled, “CONTROLLER EDITOR REMOTE SOCKET LISTENER,” filed on Mar. 20, 2025, and having Serial No. 63/774,919. The subject matter of this related application is hereby incorporated herein by reference.

### BACKGROUND

### Field of the Various Embodiments

Embodiments of the present disclosure relate generally to computer science and networking, more specifically, to establishing temporary hostname relays for client-host connectivity.

### Description of the Related Art

Cloud gaming services enable clients, such as controllers, gamepads, or computing devices, to interact with a game or software executing remotely in a data center. In typical operation, a client transmits user input – such as controller commands, button presses, or motion data – to the data center, where one or more remote servers of the data center process the inputs, execute corresponding game logic, render resulting game video frames, and encode and stream the rendered content back to the client in real time. To support such an exchange, cloud gaming services use standard internet connection protocols to provide secure, encrypted communication between the clients and the remote servers. Such approaches often require networks to be preconfigured to permit secure connections into the data center, which can include validating certificates for encrypted traffic and configuring Domain Name Systems (DNSs) to correctly route traffic to an appropriate remote server.

When developing video games for cloud gaming services, creators typically build and test the games on a development workstation rather than on the remote servers used in the production data center environment described above. A difference between a development workstation and a production data center environment can create friction because a development workstation does not benefit from a secure, preconfigured networking infrastructure – such as validated certificates and DNS routing – that supports communication between clients and servers in the production data center environment. As a result, testing gameplay that involves client devices, such as controllers or gamepads that send input over a Local Area Network (LAN), requires manual configuration on the development workstation. In particular, the development workstation often must generate a locally resolvable domain name and bind a port to receive traffic from a controller. Such an arrangement enables bidirectional communication for development and testing operations.

The foregoing LAN-based approach to connecting a controller to a development workstation suffers from several technical drawbacks. Many office or studio LANs are configured to isolate network clients – including development workstations, controllers, and other devices – from one another as a security measure. Such client isolation prevents devices on the same network from discovering or communicating with one another and blocks a controller from establishing a connection with a development workstation. In addition, various network configurations restrict clients from generating or advertising local hostnames to mitigate malicious network behavior. A development workstation that relies on a locally generated hostname bound through a local DNS mechanism cannot establish a resolvable mapping between the hostname and the Internet Protocol (IP) address of the development workstation in environments where local hostname generation is blocked. Restrictions on local hostname generation therefore impede the ability of controllers or gamepads to connect to the development workstation for testing.

A further technical limitation arises from a requirement that a controller and a development workstation reside on the same network to enable connectivity over a LAN. Many office network architectures segment devices into separate virtual LANs (VLANs) or subnets, where development workstations are grouped into one network and devices such as smartphones or tablets are grouped into a different network. Consequently, when a controller application operates on a smartphone or similar device located on a separate network, segmentation of device classes into different networks prevents the controller from reaching the development workstation over the LAN and thereby obstructs testing workflows.

As the foregoing illustrates, what is needed in the art are more effective techniques for facilitating dependable communication between client devices and development workstations during the creation and testing of cloud-based video games.

### SUMMARY

In various embodiments, a computer-implemented method for establishing communication between a local server computing device and at least one client computing device comprises establishing an initial server connection with a relay module executing; receiving, from the relay module, a temporary hostname associated with the initial server connection; providing the temporary hostname to the at least one client computing device; receiving, from the relay module, relay connection information associated with a connection established between the at least one client computing device and the relay module using the temporary hostname; generating, based on the relay connection information, a spliced connection between the local server computing device and the at least one client computing device; and communicating with the at least one client computing device over the spliced connection.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques enable reliable connectivity between a client computing device and a development workstation across network environments that otherwise prevent such connectivity. In some embodiments, a system implementing the disclosed techniques includes the client computing device, the development workstation, and a relay module communicatively coupled to one or more networks between the client computing device and the development workstation. The relay module enables bidirectional communication on host-isolated networks that block direct peer-to-peer connections between devices on a local area network (LAN). Additionally, the relay module can be configured to allow connections to the development workstation from outside of the LAN to which the development workstation is connected. The disclosed techniques further eliminate reliance on local Domain Name System (DNS) infrastructure by enabling the relay module to bind an initial server connection associated with the development workstation to a port, generate a temporary hostname for the initial server connection, and route authenticated traffic from the client computing device to the development workstation based on the temporary hostname. As a result, the development workstation does not require LAN-level hostname creation, local DNS services, or permissive network policies, and the client computing device and the development workstation can communicate even when located on different virtual LANs (VLANs), segmented subnets, cellular networks, or wide area networks (WANs).

Another technical advantage of the disclosed techniques over the prior art is that the disclosed techniques improve the fidelity and reliability of development-time communication by more closely emulating connection behavior used in data-center-based cloud-gaming deployments. In some embodiments, the relay module employs secure transport protocols, including Transport Layer Security (TLS) and QUIC, and generates authorization tokens and reconnect tokens associated with the initial server connection for authenticating the client computing device and re-establishing connectivity following network interruptions. The relay module uses the temporary hostname and the tokens to establish one or more bidirectional stream connections between the client computing device and the development workstation that reflect authentication, reconnection, and transport characteristics observed in production cloud-gaming systems. The relay module further manages a lifecycle for the temporary hostname and the associated authorization, maps multiple client connections to corresponding initial server connections, and invalidates the hostname and authorization upon termination, thereby reducing stale or orphaned connections and enabling consistent, repeatable testing across varied network configurations.

Another technical advantage of the disclosed techniques over the prior art is that the disclosed techniques generate a temporary hostname from a large, randomized namespace such that the hostname is unpredictable and is not reused across different sessions associated with the same development workstation. In that regard, the temporary hostname remains valid only while the corresponding initial server connection between the development workstation and the relay module is active and is automatically invalidated when the connection terminates. Because the relay module does not require prior provisioning of hostnames for individual developers, and because the randomized hostnames are not discoverable through local DNS mechanisms, the disclosed techniques reduce the risk of unsolicited connection attempts while eliminating manual configuration and hostname management for developers.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments.

FIG. 2 is a more detailed block diagram of the content server of FIG. 1, according to various embodiments.

FIG. 3 is a more detailed block diagram of the control server of FIG. 1, according to various embodiments.

FIG. 4 is a more detailed block diagram of the endpoint device of FIG. 1, according to various embodiments.

FIG. 5 is a block diagram illustrating a computing environment configured to implement one or more aspects of the disclosed embodiments.

FIG. 6 is a block diagram illustrating the server computing device establishing a connection to the client compute device using a relay, according to various embodiments.

FIG. 7 is a flow diagram of method steps illustrating a server connecting to a client device, according to various embodiments.

FIG. 8 is a flow diagram of method steps illustrating a relay configuring a connection between two devices, according to various embodiments.

FIG. 9 is a flow diagram of method steps illustrating a client connecting to a server using a relay, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described herein, cloud gaming services enable client devices such as controllers, gamepads, or computing systems to transmit user input to remote servers in a data center. The remote servers process the input, execute game logic, render audiovisual output, and stream the resulting content back to the client using secure network protocols that depend on properly configured certificates and DNS routing. During game development, creators typically test games on local workstations that do not include such a preconfigured networking infrastructure. Consequently, developers must manually create locally resolvable hostnames and bind ports on the workstation in order to receive traffic from a controller. This LAN-based approach, however, is fragile in practice. In particular, many office or studio networks enforce client isolation, which prevents devices on the same LAN from communicating with one another. Some environments also block local hostname generation to reduce the risk of malicious network activity. Connectivity can also fail when a controller and a workstation are placed on different VLANs, different subnets, or different networks, including cases where the controller is connected through Wi-Fi, cellular data, or a VPN. These limitations make it difficult or impossible for controllers to reliably reach development workstations during testing.

To address the foregoing issues, the disclosed techniques provide a comprehensive approach for enabling a client computing device that implements a controller application to communicate with a local server computing device that implements a controller editor, even when the client computing device and the local server computing device cannot establish direct connectivity through conventional local area network mechanisms. The controller editor begins by opening an initial server connection to a relay module. The relay module authenticates the controller editor and generates a temporary hostname associated exclusively with the initial server connection. The temporary hostname is dynamically created for the session, is not reused across sessions, and serves as the unique network identifier through which subsequent client connections are routed to the controller editor.

After receiving connection details – including the temporary hostname and an authorization packet – from the relay module, the controller editor conveys the connection details to the controller application executing on the client computing device. In some embodiments, the connection details are provided via a QR code that the controller application can scan. The controller application then establishes a secure connection to the relay module using the temporary hostname, and, when applicable, the authorization packet. The relay module extracts the temporary hostname from the secure connection, maps the temporary hostname to the corresponding initial server connection associated with the controller editor, and determines that the controller application is authorized to connect.

In turn, the relay module creates a spliced connection that couples a client stream connection from the controller application to a server stream connection directed to the controller editor. In embodiments where the initial server connection employs a stream-multiplexed transport such as QUIC, the relay module generates a new stream for each client stream connection. Through the spliced connection, the controller application transmits controller inputs, configuration data, or other communication to the controller editor, and the controller editor returns response data or configuration updates to the controller application. The spliced connection enables bidirectional communication while completely bypassing limitations associated with LAN isolation, blocked DNS resolution, restricted host-listening capabilities, or network segmentation across different virtual LANs, subnets, or wireless networks.

Additionally, the disclosed techniques support reconnection procedures for both the controller editor and the controller application. In particular, following an interruption, the relay module can issue a reconnect token that allows the controller editor to re-establish the initial server connection and reclaim the same temporary hostname. The relay module may also allow the controller application to re-establish the client stream connection using the authorization packet provided through the controller editor. Such mechanisms allow the development workflow to continue without requiring repeated scanning of QR codes or restarting of development sessions.

When the controller application terminates the client stream connection, or when the controller editor terminates the initial server connection, the relay module closes all associated streams, releases the temporary hostname, and invalidates the authorization packet and any reconnect tokens. The relay module can then reuse network resources for subsequent sessions without retaining stale or orphaned mappings.

One technical advantage of the disclosed techniques over the prior art is that the disclosed techniques enable reliable connectivity between a client computing device and a development workstation across network environments that otherwise prevent such connectivity. In some embodiments, a system implementing the disclosed techniques includes the client computing device, the development workstation, and a relay module communicatively coupled to one or more networks between the client computing device and the development workstation. The relay module enables bidirectional communication on host-isolated networks that block direct peer-to-peer connections between devices on a local area network (LAN). Additionally, the relay module can be configured to allow connections to the development workstation from outside of the LAN to which the development workstation is connected. The disclosed techniques further eliminate reliance on local Domain Name System (DNS) infrastructure by enabling the relay module to bind an initial server connection associated with the development workstation to a port, generate a temporary hostname for the initial server connection, and route authenticated traffic from the client computing device to the development workstation based on the temporary hostname. As a result, the development workstation does not require LAN-level hostname creation, local DNS services, or permissive network policies, and the client computing device and the development workstation can communicate even when located on different virtual LANs (VLANs), segmented subnets, cellular networks, or wide area networks (WANs).

Another technical advantage of the disclosed techniques over the prior art is that the disclosed techniques improve the fidelity and reliability of development-time communication by more closely emulating connection behavior used in data-center-based cloud-gaming deployments. In some embodiments, the relay module employs secure transport protocols, including Transport Layer Security (TLS) and QUIC, and generates authorization tokens and reconnect tokens associated with the initial server connection for authenticating the client computing device and re-establishing connectivity following network interruptions. The relay module uses the temporary hostname and the tokens to establish one or more bidirectional stream connections between the client computing device and the development workstation that reflect authentication, reconnection, and transport characteristics observed in production cloud-gaming systems. The relay module further manages a lifecycle for the temporary hostname and the associated authorization, maps multiple client connections to corresponding initial server connections, and invalidates the hostname and authorization upon termination, thereby reducing stale or orphaned connections and enabling consistent, repeatable testing across varied network configurations.

Another technical advantage of the disclosed techniques over the prior art is that the disclosed techniques generate a temporary hostname from a large, randomized namespace such that the hostname is unpredictable and is not reused across different sessions associated with the same development workstation. In that regard, the temporary hostname remains valid only while the corresponding initial server connection between the development workstation and the relay module is active and is automatically invalidated when the connection terminates. Because the relay module does not require prior provisioning of hostnames for individual developers, and because the randomized hostnames are not discoverable through local DNS mechanisms, the disclosed techniques reduce the risk of unsolicited connection attempts while eliminating manual configuration and hostname management for developers.

These technical advantages provide one or more technological advancements over prior art approaches.

### System Overview

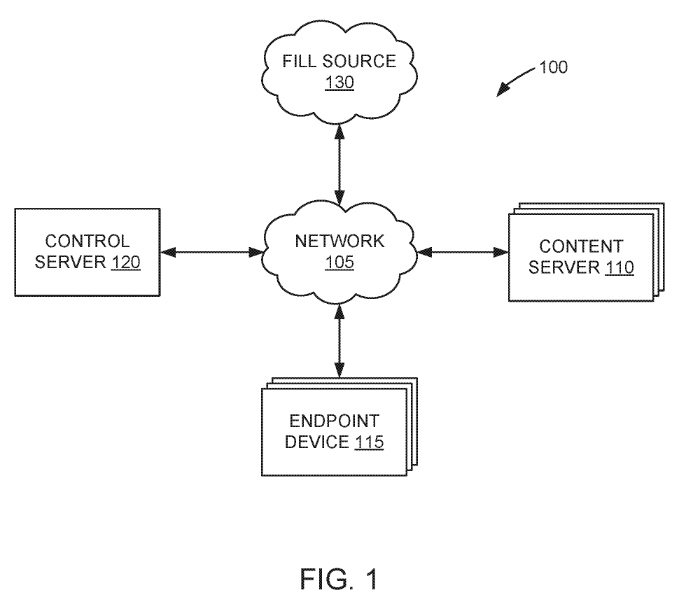

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which is connected via a communications network 105. The network 105 can represent, for example, any technically feasible network or number of networks, including a wide area network (WAN) such as the Internet, a local area network (LAN), a Wi-Fi network, a cellular network, or a combination thereof.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in some embodiments multiple fill sources 130 may be implemented to service requests for files. Further, as is well-understood, any cloud-based services can be included in the architecture of FIG. 1 beyond fill source 130 to the extent desired or necessary.

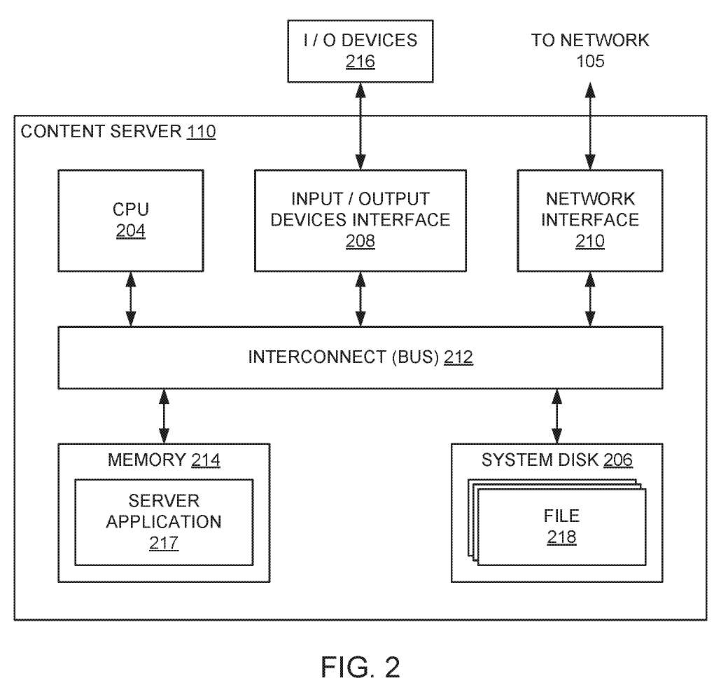

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as a server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, the I/O devices interface 208, the network interface 210, and the system memory 214. The I/O devices interface 208 is configured to receive input data from I/O devices 216 and transmit the input data to the CPU 204 via the interconnect 212. For example, the I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes the server application 217, which is configured to service requests for files 218 received from an endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

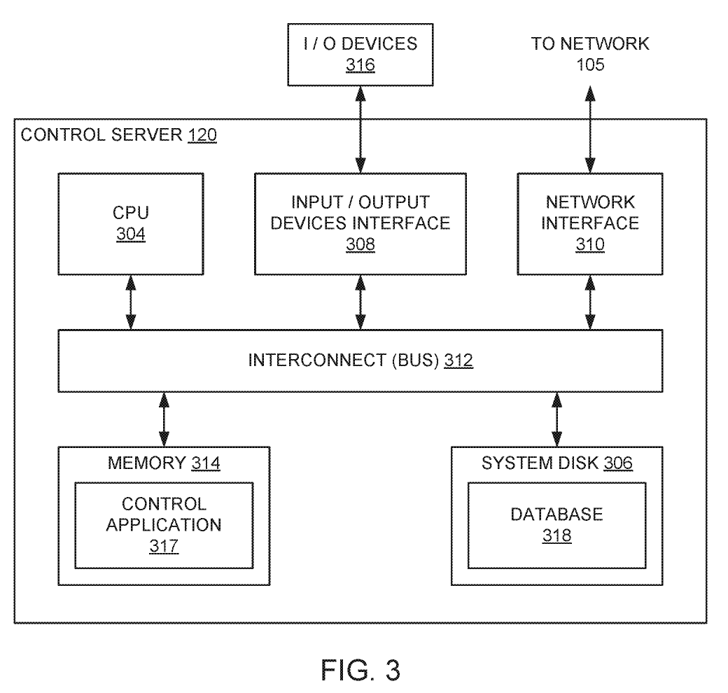

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as a control application 317, stored in the system memory 314. Similarly, the CPU 304 is configured to store application data (e.g., software libraries) and to retrieve application data from the system memory 314 and a database 318 stored in the system disk 306. The interconnect 312 is configured to facilitate transmission of data between the CPU 304, the system disk 306, the I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and similar storage devices. The system disk 306 is configured to store the database 318 of information associated with the content servers 110, the fill source(s) 130, and the files 218.

The system memory 314 includes the control application 317, which is configured to access information stored in the database 318 and process such information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via the control application 317 that compresses the files 218 prior to transmission to an endpoint device 115. Alternatively, and without limitation, the files 218 stored in the fill source 130 could be compressed, via an encoding pipeline within the system 100, prior to storage.

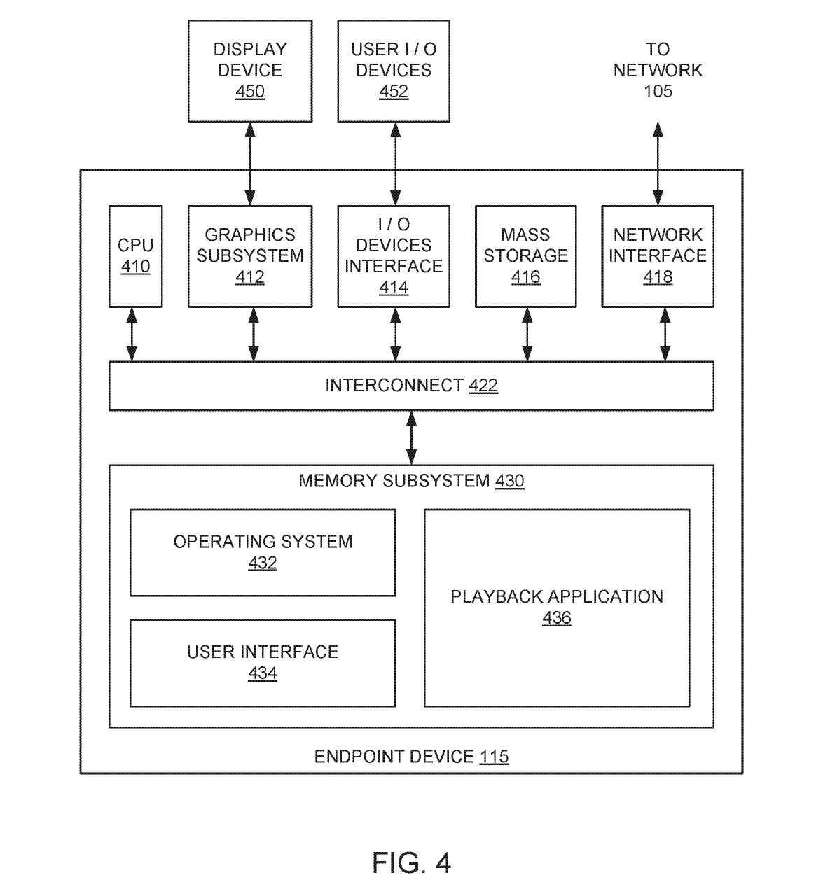

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, the graphics subsystem 412, the I/O devices interface 414, the mass storage 416, the network interface 418, and the memory subsystem 430.

In some embodiments, the graphics subsystem 412 is configured to generate frames of video data and transmit the frames of video data to a display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, the mass storage 416, the I/O device interface 414, and the graphics subsystem 412. The operating system 432 also provides process and memory management models for the user interface 434 and the playback application 436. The user interface 434, such as a window and object metaphor, provides a mechanism for user interaction with the endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via the display device 450 and/or the user I/O devices 452. In one embodiment, the playback application 436 may include a decoding pipeline that decodes compressed content prior to display via the display device 450.

### Controller Editor Remote Socket Listener

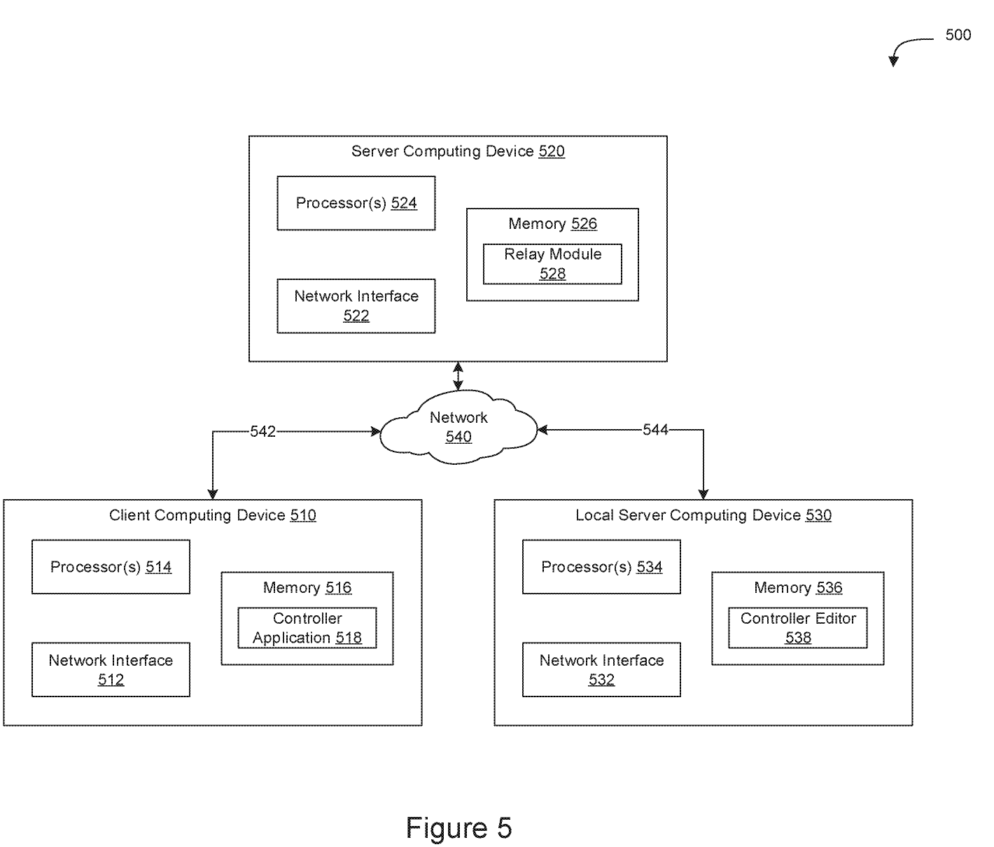

FIG. 5 is a block diagram illustrating a computing environment 500 configured to implement one or more aspects of the various embodiments. As shown in FIG. 5, the computing environment 500 includes a client computing device 510, a server computing device 520, a local server computing device 530, and a network 540.

As shown, the client computing device 510 includes, without limitation, a network interface 512, one or more processors 514, and a memory 516. The memory 516 includes, without limitation, a controller application 518. The controller application 518, as described in greater detail herein, can be used to interact with software, such as a video game, hosted on a server or workstation on a local area network (LAN) or in a data center.

The server computing device 520 includes, without limitation, a network interface 522, one or more processors 524, and a memory 526. The memory 526 includes, without limitation, a relay module 528. The relay module 528, as described in greater detail herein, can be used to generate a network connection between one or more controller applications 518 and the controller editor 538.

The local server computing device 530 includes, without limitation, a network interface 532, one or more processors 534, and a memory 536. The memory 536 includes, without limitation, a controller editor 538. The controller editor 538, as described in greater detail herein, is software that receives inputs from a video game controller, such as a game pad or other controller software, and provides such inputs to a video game development environment on a workstation or server.

As described herein, the compute environment 500 is configured to allow the controller application 518 to connect to the controller editor 538 through the relay module 528 over the network 540. The client computing device 510 can be any smart phone device, cloud-enabled controller for video games, and/or the like, and can execute the controller application 518 to be used as an input device for video games.

To allow connections over the network 540, the controller editor 538 opens a server connection 544 to the relay module 528 over the network 540. In some embodiments, the server connection 544 is established using the QUIC protocol. The relay module 528 then binds a socket listener on an available port on the relay module 528 to the connection from the controller editor 538. The relay module 528 maintains the connection from the controller editor 538 on the assigned port until the controller editor 538 disconnects from the relay module 528. To provide connectivity to the controller editor 538, the relay module 528 assigns the bound connection to a temporary hostname and provides a method for authentication. The method of authentication can be an authorization token and/or similar mechanism.

According to some embodiments, the relay module 528 returns the hostname and an authentication token to the controller editor 538. The controller editor 538 provides the hostname and the authentication token to the controller application 518, for example by encoding the hostname and the authentication token in a Quick Response (QR) code. To initiate communication with the controller editor 538, the controller application 518 establishes a client connection 542 to the relay module 528 by connecting to a Transmission Control Protocol with Transport Layer Security (TCP/TLS) socket exposed by the relay module 528. The controller application 518 uses the hostname as the TLS connection target and transmits the hostname during the TLS handshake by using a Server Name Indication (SNI) extension of TLS. The relay module 528 terminates the TLS connection established by the controller application 518, extracts the hostname from the SNI information, and uses the extracted hostname to identify a corresponding server connection 544 that has been registered by the controller editor 538 with the relay module 528.

In some embodiments, the server connection 544 is implemented using a QUIC transport protocol between the controller editor 538 executing on the local server computing device 530 and the relay module 528. The relay module 528 establishes a logical splice between the TCP/TLS client connection 542 and the server connection 544 associated with the hostname, thereby enabling bidirectional data exchange between the controller application 518 and the controller editor 538 across different underlying transport protocols. To prevent unintended termination of the logical connection between the controller application 518 and the controller editor 538, the controller application 518 or the controller editor 538 can provide a reconnect token to the relay module 528, thereby enabling re-establishment of a TCP/TLS client connection 542 and a corresponding server connection 544 that are associated in the same manner as described above.

In some embodiments, the bidirectional communication between the controller application 518 and the controller editor 538 established via the relay module 528 is used primarily for control and signaling traffic, such as authentication messages and game control protocol exchanges that negotiate a separate, peer-to-peer media connection. For example, the controller application 518 and the controller editor 538 can use the relay-mediated connection to establish a Web Real-Time Communication (WebRTC) session that carries latency-sensitive input data and media streams directly between the client computing device 510 and the local server computing device 530. In other embodiments, some or all of the controller input data is conveyed over the spliced connection provided by the relay module 528 without establishing a separate peer-to-peer media path.

In some embodiments, the relay module 528 can connect with multiple local server computing devices 530. The relay module 528 maps separate hostnames for each client device, and routes connections from one or more client computing devices 510 to the appropriate local server computing device 530. In additional embodiments, the relay module 528 can connect multiple client computing devices 510 to a local server computing device 530.

When all controller application(s) 518 terminate connection to the controller editor 538, and the controller editor 538 terminates connection with the relay module 528, the relay module 528 terminates the spliced connection. The bound hostname is then released and previously assigned tokens are invalidated.

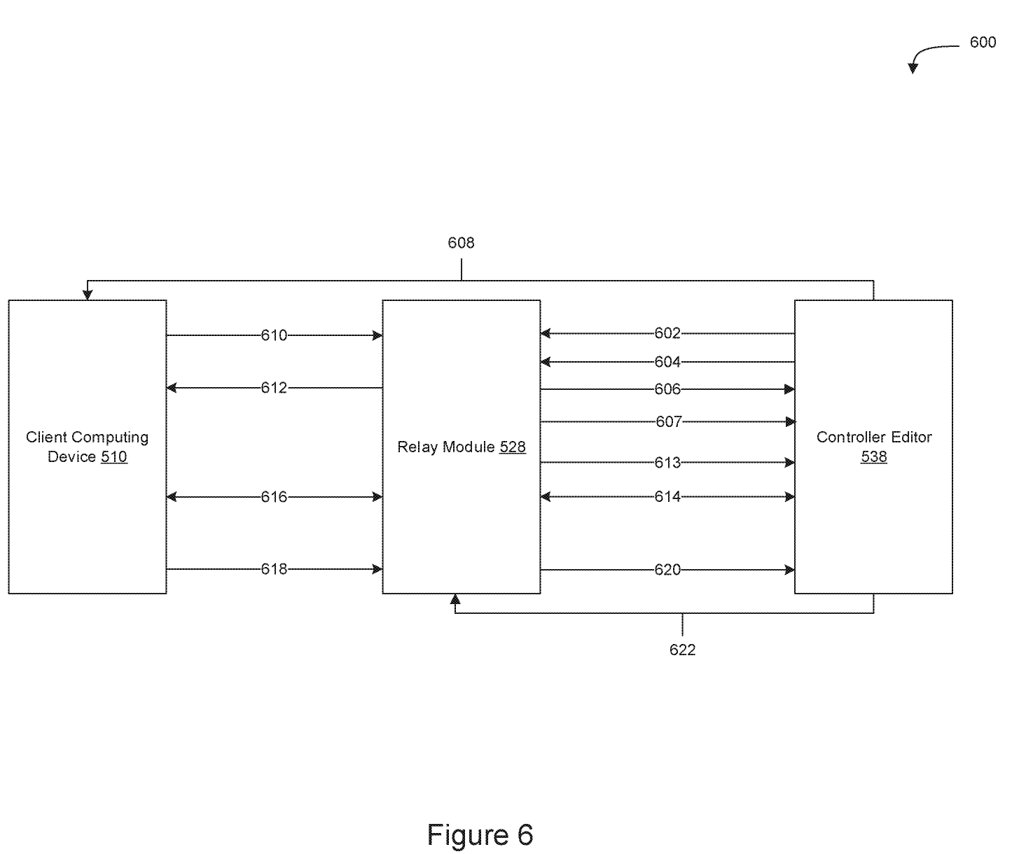

FIG. 6 is a process flow illustrating the local server computing device 530 establishing a connection to the client computing device 510 using a relay module 528. The process flow 600 involves the local server computing device 530 establishing a temporary domain name using the relay module 528, sharing a temporary domain name and authorization to the client computing device 510, and establishing a connection with the client computing device 510 using a temporary domain name and authorization.

As shown, the controller editor 538 opens an initial server connection 602 to the relay module 528. In some embodiments, the initial server connection 602 is established using the QUIC protocol. Once the initial server connection 602 has been established, the controller editor 538 sends an authorization request 604 to the relay module 528. The authorization can be sent in a text-based format such as JavaScript Object Notation (JSON) and can include a token used as a secret for the connection, a token for reconnection, and/or similar elements. The relay module 528 then validates the authorization request 604 and binds the initial server connection 602 to the socket listener using a temporary or otherwise ephemeral hostname 606. The relay module 528 returns a response that includes the status of the request, the hostname 606, and an authorization packet 607. The authorization packet 607 can be credentials used to authentication to the local server computing device 530. The authorization packet 607 can be returned in a text-based format such as JavaScript Object Notation (JSON) and can include, without limitation, a token that can be used for authorization to the relay module 528 by external devices, a token that can be used to re-establish a connection, and/or similar elements. The initial server connection 602 can then be forwarded to an external device using secure connection methods such as Transport Layer Security (TLS). The hostname 606 and the authorization packet 607 for clients to connect to the hostname 606 are returned to the controller editor 538.

Although the examples described herein primarily discuss utilizing the QUIC protocol to establish the initial server connection 602 and to create one or more stream connections 613 between the relay module 528 and the controller editor 538, it should be understood that other secure, stream-multiplexing transport protocols may be used in alternative embodiments. For example, the relay module 528 and the controller editor 538 may communicate via HTTP/3 over QUIC, HTTP/2 over TLS, or a custom transport protocol that provides multiple bidirectional streams over a single secure connection. In each case, the relay module 528 can splice individual client connections to corresponding streams on the server connection while preserving the temporary hostname semantics and authorization mechanisms described herein.

It is noted that the foregoing examples are not meant to be limiting, and that any amount, type, form, etc., of transport protocols can be utilized to implement the techniques described herein, consistent with the scope of this disclosure.

As shown, the controller editor 538 then provides the hostname 606 and the authorization packet 607 to the client computing device 510 via a credential share 608. Once shared, the client computing device 510 connects to the relay module 528 using a secure connection 610 and a handshake is established to the relay module 528. In some embodiments, the sharing of the hostname 606 and the authorization packet 607 token with the client computing device 510 is done via a Quick Response (QR) code. For example, the controller editor 538 displays a QR code encoded with the hostname 606 and the authorization packet 607, and the QR code is scanned by a smartphone device, opening the controller application 518 and connecting to the relay module 528. The secure connection 610 can be a Hypertext Transfer Protocol Secure (HTTPS) connection between the client computing device 510 and the relay module 528. In some embodiments, the secure connection 610 is a TLS connection that emulates the connection the client computing device 510 makes to a server hosted in a data center. In further embodiments, two or more client computing devices 510 can connect to the relay module 528 simultaneously with separate secure connections 610 received by the relay module 528 for each device.

As shown, the relay module 528 looks up the hostname 606 associated with the secure connection 610 and maps the secure connection 610 to the initial server connection 602. In some embodiments, the hostname 606 and the authorization packet 607 are encrypted using TLS and are provided with the secure connection 610. The relay module 528 can then extract the hostname 606 from the secure connection 610 to map to the initial server connection 602. In some embodiments, where the secure connection 610 cannot be mapped to an initial server connection 602, the relay module 528 closes the connection with the client computing device 510. Once the relay module 528 determines the controller editor 538 for the secure connection 610, the relay module 528 opens a connection 613 with the controller editor 538. In some embodiments, the connection 613 is a QUIC stream between the relay module 528 and the controller editor 538.

As shown, the relay module 528 then splices the secure connection 610 with the connection 613 to generate a client stream connection 616 from the client computing device 510 and a server stream connection 614 to the controller editor 538. In some embodiments, the relay module 528 terminates a TLS connection from the client computing device 510 and uses the QUIC protocol to generate a stream between the client computing device 510 and the controller editor 538 as the connection 613. The client computing device 510 can then send input or receive output with the controller editor 538 over the client stream connection 616. Similarly, the controller editor 538 can receive input or send output to the client computing device 510 over the server stream connection 614. In some embodiments, the server stream connection 614 can be re-established in the event of a disconnect. For example, if the local server computing device 530 that implements the controller editor 538 loses connectivity to a network, then the relay module 528 can remap the server stream connection 614 using an authorization token. The client computing device 510 using the client stream connection 616 would then resume connectivity to the controller editor 538 over the same client stream connection 616.

Finally, the client computing device 510 terminates the connection to the relay module 528 with a client disconnect 618. The controller editor 538 then closes the stream connection 616 with the relay module 528 with a relay disconnect 620. After the client disconnect 618 and the relay disconnect 620, the relay module 528 releases the hostname binding upon receiving server disconnect 622 on the hostname 606 and invalidates the authentication 607. The relay module 528 can then re-use any ports, sockets, or hostnames for future connections.

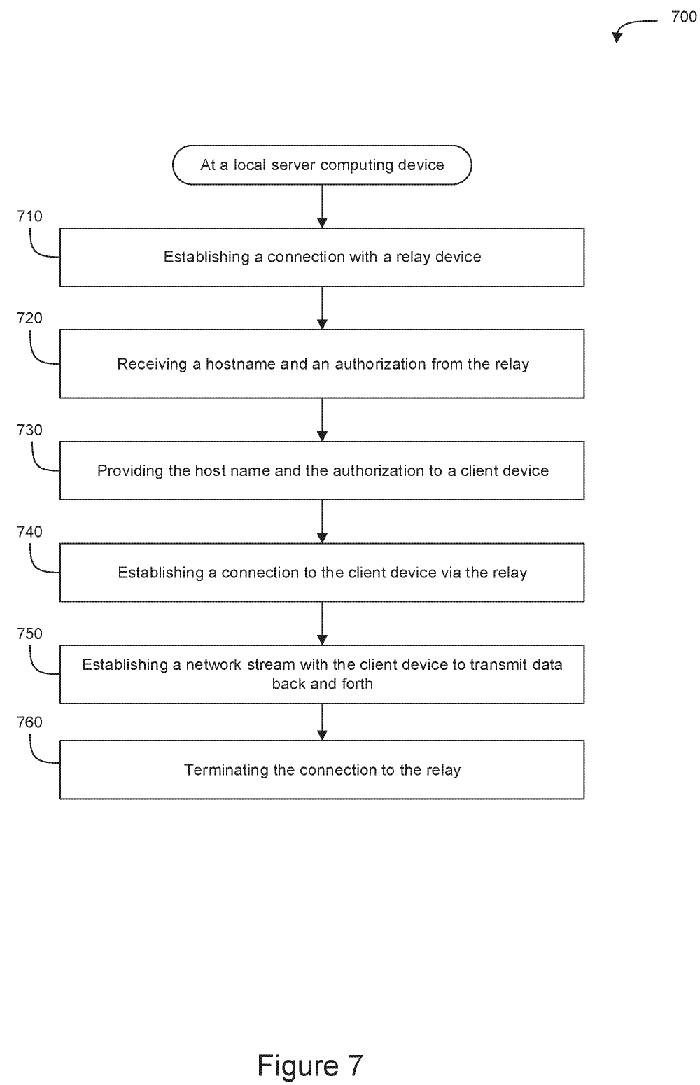

FIG. 7 is a flow diagram of method steps illustrating a server connecting to a client device, according to various embodiments. Although the method steps are described in conjunction with the embodiments of FIGS. 5 and 6, persons of ordinary skill in the art will understand that any system configured to perform the method steps, in any order, is within the scope of the invention.

According to some embodiments, the method 700 involves a local server computing device 530 that implements a controller editor 538 establishing a bidirectional server stream connection 614 to a client computing device 510 that implements a controller application 518. The bidirectional server stream connection 614 is established through a relay module 528, as described herein.

At a method step 710, a connection is established with the relay module 528. An initial server connection 602 is established by the controller editor 538 with the relay module 528 as a socket listener bound to a port on the relay module 528. In some embodiments, the initial server connection 602 is established between the controller editor 538 and the relay module 528 using the QUIC protocol. The initial server connection 602 utilizes a secure connection between the relay module 528 and the controller editor 538.

At a method step 720, a hostname and an authorization from the relay module 528 are received. The controller editor 538 submits an authorization request 604 to the relay module 528 and receives a hostname 606 and an authorization packet 607. The hostname 606 and the authorization packet 607 are provided via an API response that can take the form of a JSON object and/or a similar text format. The hostname 606 is a temporary domain name established by the relay module 528 that can be mapped back to the initial server connection 602. The authorization packet 607 can be an authorization token used to establish connections from one or more client devices to the controller editor 538. In some embodiments, the hostname 606 and the authorization packet 607 additionally include a reconnect token for the controller editor 538 to re-establish the initial server connection 602 in the event of a disconnect.

In some embodiments, possession of the hostname 606 alone is sufficient to authorize a client computing device 510 to connect to the controller editor 538 via the relay module 528. In particular, because the hostname 606 can be randomly generated, is not advertised through local DNS mechanisms, and is valid only for the lifetime of the initial server connection 602, knowledge of the hostname 606 can function as a capability that implicitly authorizes the client computing device 510 to reach the corresponding controller editor 538. In other embodiments, a client computing device 510 presents both the hostname 606 and at least a portion of the authorization packet 607, such as an authorization token, to the relay module 528. The relay module 528 can then validate the authorization packet 607 before splicing the secure connection 610 to the initial server connection 602.

At a method step 730, the hostname 606 and authorization packet 607 are provided to the client device. The controller editor 538 shares the hostname 606 and authorization packet 607 with the client computing device 510. In some embodiments, the hostname 606 and the authorization packet 607 are shared with the client computing device 510 via a QR code. The hostname 606 and the authorization packet 607 allow the client computing device 510 to establish a connection with the relay module 528 that can be mapped to the initial server connection 602 between the relay module 528 and the controller editor 538.

At a method step 740, a connection is established to the client device via the relay module 528. The client computing device 510 connects to the relay module 528 via a secure connection 610. The relay module 528 then maps the hostname 606 and authorization packet 607 to the initial server connection 602 with the controller editor 538. The controller editor 538 then receives a connection 613 from the relay module 528 that includes a spliced connection with the client computing device 510.

At a method step 750, the server and client device establish a network stream and transmit data back and forth. The server stream connection 614 is a bidirectional data stream between the controller editor 538 and the client computing device 510. Similarly, a client stream connection 616 is a bidirectional data stream between the client computing device 510 and the controller editor 538. The controller editor 538 receives inputs, such as inputs for a video game, over the server stream connection 614 from the client computing device 510 via the client stream connection 616. The controller editor 538 can send data, such as configuration details, to the client computing device 510 over the server stream connection 614. The client computing device 510 receives data from the controller editor 538 over the client stream connection 616 via the server stream connection 614.

Finally, at a method step 760, the connection to the relay module 528 is terminated. The controller editor 538 receives a relay disconnect 620 from the relay module 528. The relay disconnect 620 signifies that the client computing device 510 has terminated the client stream connection 616. The controller editor 538 then sends a server disconnect 622, closing all connections to the controller editor 538 with the relay module 528.

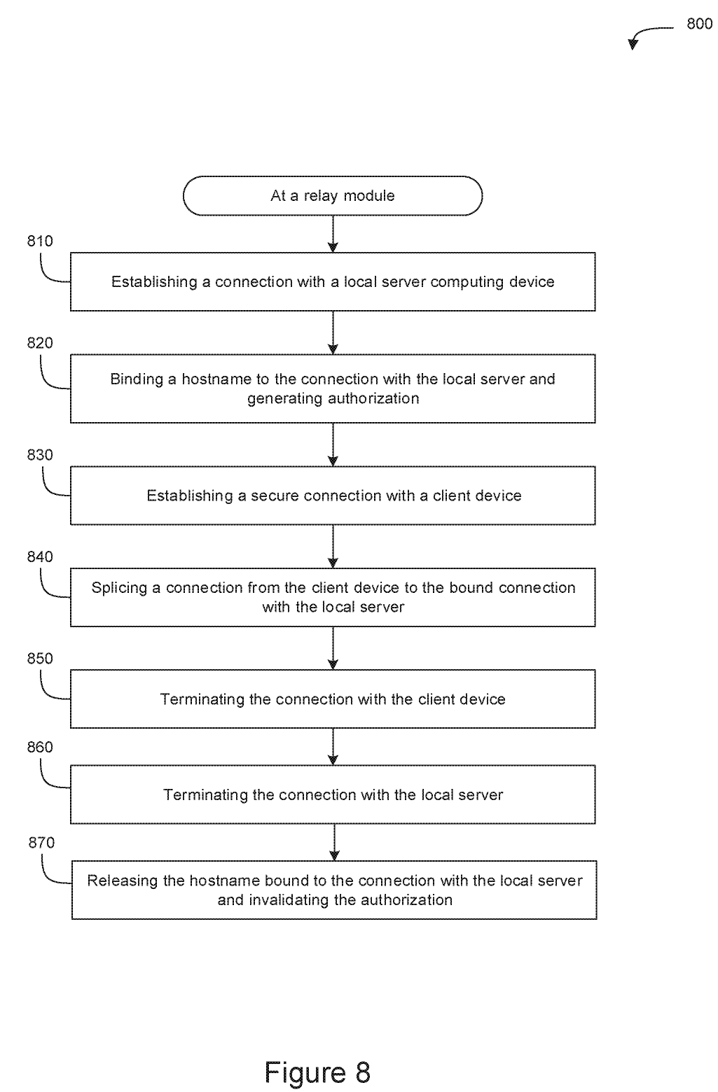

FIG. 8 is a flow diagram of method steps illustrating a relay configuring a connection between two devices, according to various embodiments. Although the method steps are described in conjunction with the embodiments of FIGS. 5 and 6, persons of ordinary skill in the art will understand that any system configured to perform the method steps, in any order, is within the scope of the invention.

According to some embodiments, the method 800 involves a relay module 528 establishing a connection between a local server computing device 530 that implements a controller editor 538 and a client computing device 510 that implements a controller application 518. The relay module 528 establishes a bidirectional server stream connection 614 and one or more client stream connections 616.

At a method step 810, a connection is established with the local server computing device 530. The relay module 528 receives an initial server connection 602 as a socket listener from the controller editor 538. In some embodiments, the initial server connection 602 is established using the QUIC protocol. Once the initial server connection 602 is established, the relay module 528 receives an authorization request 604 from the controller editor 538.

At a method step 820, a hostname is bound to the connection with the local server computing device 530 and authorization is generated. The relay module 528 validates the authorization request 604, and a hostname 606 and an authorization packet 607 are generated by the relay module 528. The hostname 606 is then bound to the initial server connection 602 including a socket listener and/or stream connection with the controller editor 538. The authorization packet 607 allows the client computing device 510 to authenticate with the relay module 528, and subsequently the relay module 528 can connect the client computing device 510 with the controller editor 538. The relay module 528 then returns the hostname 606 and the authorization packet 607 to the controller editor 538.

At a method step 830, a connection is received from the client computing device 510. The relay module 528 receives a secure connection 610 from the client computing device 510 including the controller application 518. The relay module 528 then receives the hostname 606 and the authorization packet 607 from the client computing device 510.

At a method step 840, the connection from the client computing device 510 is spliced to the bound connection with the server. The relay module 528 maps the hostname 606 received from the client computing device 510 to the initial server connection 602 with the controller editor 538. The relay module 528 then establishes a spliced connection 612 with the client computing device 510 that can be used to establish bidirectional communication between the controller editor 538 and the client computing device 510. Additionally, the relay module 528 generates a reconnect token for the client computing device 510 to re-establish the spliced connection 612. In some embodiments, the hostname 606 and/or the authorization packet 607 are invalid, and the relay module 528 terminates the secure connection 610 with the client computing device 510. For example, the hostname 606 may no longer be bound to the initial server connection 602, and therefore the relay module 528 closes the secure connection 610. In some embodiments, the relay module 528 generates the spliced connection 612 for two or more client computing devices 510 such that each client computing device 510 can use the spliced connection 612 to establish separate connections with the controller editor 538.

At a method step 850, the client connection to the relay is terminated. The relay module 528 receives a client disconnect 618 from the client computing device 510 and terminates the client stream connection 616 with the client computing device 510. In some embodiments, the relay module 528 re-establishes the client stream connection 616 for the client computing device 510 using a reconnect token.

At a method step 860, the local server connection to the relay is terminated. The relay module 528 closes the connection 613 when a server disconnect 622 is received from the controller editor 538. In some embodiments, the relay module 528 receives a reconnect token from the controller editor 538 that can be used to re-establish the server stream connection 614.

At a method step 870, the hostname 606 is released, and authorization packet 607 is invalidated. The relay module 528 removes the mapping between the hostname 606 and the authorization packet 607 with the controller editor 538. The relay module 528 can then reuse the socket and/or the hostname 606 for future connections.

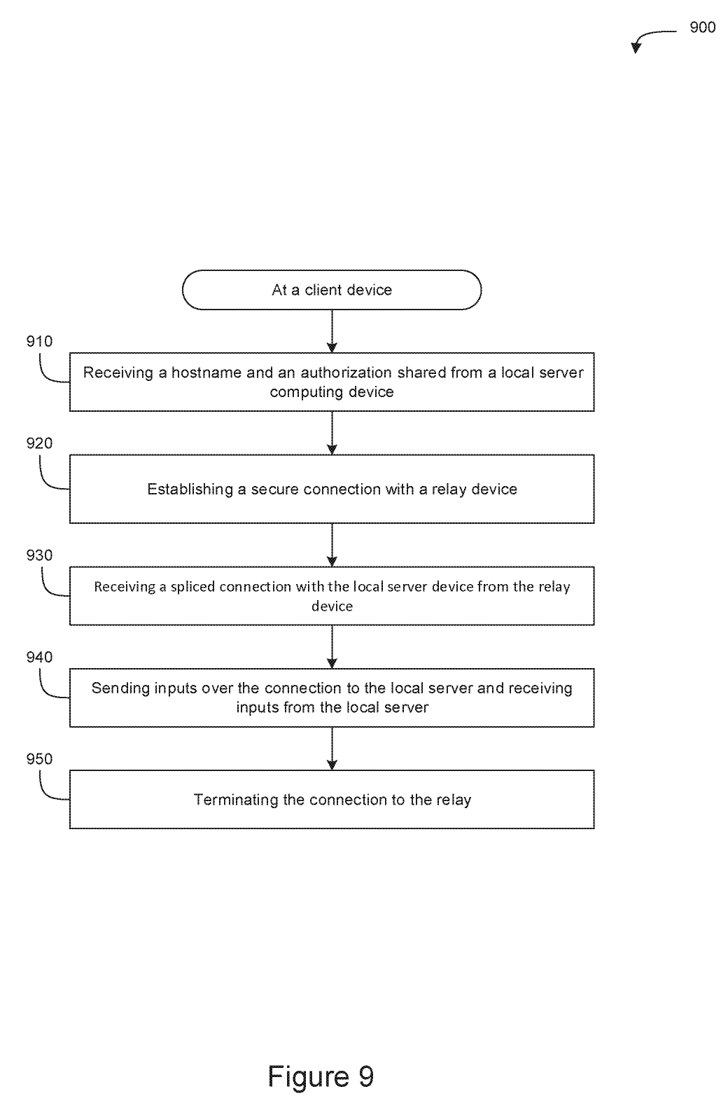

FIG. 9 is a flow diagram of method steps illustrating a client connecting to a server using a relay, according to some embodiments. Although the method steps are described in conjunction with the embodiments of FIGS. 5 and 6, persons of ordinary skill in the art will understand that any system configured to perform the method steps, in any order, is within the scope of the invention.

According to some embodiments, the method 900 involves a relay module 528 establishing a connection between a local server computing device 530 that implements a controller editor 538 and a client computing device 510 that implements a controller application 518. The relay module 528 generates a bidirectional server stream connection 614 and one or more client stream connections 616.

At a method step 910, a hostname 606 and an authorization packet 607 are received from the local server computing device 530. The controller application 518 receives the hostname 606 and the authorization packet 607 to authenticate with the relay module 528. In some embodiments, the hostname 606 and the authorization packet 607 are received from the local server computing device 530 as a QR code. For example, the client computing device 510 scans the QR code using the controller application 518. The QR code encodes the hostname 606 and the authorization packet 607.

At a method step 920, a secure connection is established with the relay module 528. The client computing device 510 authenticates with the relay module 528 using the hostname 606 and the authorization packet 607 and establishes a secure connection 610 with the relay module 528. The secure connection 610 can be a TLS, HTTPS, or other standard, secure connection protocol.

At a method step 930, the secure connection 610 with the relay module 528 is spliced with a connection with the local server computing device 530. The client computing device 510 receives a spliced connection 612 from the relay module 528. The spliced connection 612 can be used to generate a client stream connection 616. For example, the secure connection 610 can be altered by the relay module 528 to include elements of the initial server connection 602 between the local server computing device 530 and the relay module 528. The spliced connection 612 can then be used by the client computing device 510 to connect directly with the local server computing device 530.

At a method step 940, inputs are sent over the client stream connection 616 to the local server computing device 530, and input can be received from the local server computing device 530. The client computing device 510 communicates with the controller editor 538 via the client stream connection 616 with the local server computing device 530. For example, the client computing device 510 can send inputs, such as inputs for a video game, and can receive configurations for the controller application 518 from the controller editor 538.

At a method step 950, the connection to the relay module 528 is terminated. The client computing device 510 sends a client disconnect 618 to the relay module 528, which causes the connection to the controller editor 538 to be closed. In some embodiments, the authorization packet 607 includes a reconnect token that allows the client computing device 510 to reconnect to the relay module 528. The reconnect token can then be sent to the relay module 528 to reestablish the client stream connection 616 to the controller editor 538.

In sum, the disclosed techniques provide a comprehensive approach for enabling a client computing device that implements a controller application to communicate with a local server computing device that implements a controller editor, even when the client computing device and the local server computing device cannot establish direct connectivity through conventional local area network mechanisms. The controller editor begins by opening an initial server connection to a relay module. The relay module authenticates the controller editor and generates a temporary hostname associated exclusively with the initial server connection. The temporary hostname is dynamically created for the session, is not reused across sessions, and serves as the unique network identifier through which subsequent client connections are routed to the controller editor.

After receiving connection details – including the temporary hostname and an authorization packet – from the relay module, the controller editor conveys the connection details to the controller application executing on the client computing device. In some embodiments, the connection details are provided via a QR code that the controller application can scan. The controller application then establishes a secure connection to the relay module using the temporary hostname, and, when applicable, the authorization packet. The relay module extracts the temporary hostname from the secure connection, maps the temporary hostname to the corresponding initial server connection associated with the controller editor, and determines that the controller application is authorized to connect.

In turn, the relay module creates a spliced connection that couples a client stream connection from the controller application to a server stream connection directed to the controller editor. In embodiments where the initial server connection employs a stream-multiplexed transport such as QUIC, the relay module generates a new stream for each client stream connection. Through the spliced connection, the controller application transmits controller inputs, configuration data, or other communication to the controller editor, and the controller editor returns response data or configuration updates to the controller application. The spliced connection enables bidirectional communication while completely bypassing limitations associated with LAN isolation, blocked DNS resolution, restricted host-listening capabilities, or network segmentation across different virtual LANs, subnets, or wireless networks.

Additionally, the disclosed techniques support reconnection procedures for both the controller editor and the controller application. In particular, following an interruption, the relay module can issue a reconnect token that allows the controller editor to re-establish the initial server connection and reclaim the same temporary hostname. The relay module may also allow the controller application to re-establish the client stream connection using the authorization packet provided through the controller editor. Such mechanisms allow the development workflow to continue without requiring repeated scanning of QR codes or restarting of development sessions.

When the controller application terminates the client stream connection, or when the controller editor terminates the initial server connection, the relay module closes all associated streams, releases the temporary hostname, and invalidates the authorization packet and any reconnect tokens. The relay module can then reuse network resources for subsequent sessions without retaining stale or orphaned mappings.

One technical advantage of the disclosed techniques over the prior art is that the disclosed techniques enable reliable connectivity between a client computing device and a development workstation across network environments that otherwise prevent such connectivity. In some embodiments, a system implementing the disclosed techniques includes the client computing device, the development workstation, and a relay module communicatively coupled to one or more networks between the client computing device and the development workstation. The relay module enables bidirectional communication on host-isolated networks that block direct peer-to-peer connections between devices on a local area network (LAN). Additionally, the relay module can be configured to allow connections to the development workstation from outside of the LAN to which the development workstation is connected. The disclosed techniques further eliminate reliance on local Domain Name System (DNS) infrastructure by enabling the relay module to bind an initial server connection associated with the development workstation to a port, generate a temporary hostname for the initial server connection, and route authenticated traffic from the client computing device to the development workstation based on the temporary hostname. As a result, the development workstation does not require LAN-level hostname creation, local DNS services, or permissive network policies, and the client computing device and the development workstation can communicate even when located on different virtual LANs (VLANs), segmented subnets, cellular networks, or wide area networks (WANs).

Another technical advantage of the disclosed techniques over the prior art is that the disclosed techniques improve the fidelity and reliability of development-time communication by more closely emulating connection behavior used in data-center-based cloud-gaming deployments. In some embodiments, the relay module employs secure transport protocols, including Transport Layer Security (TLS) and QUIC, and generates authorization tokens and reconnect tokens associated with the initial server connection for authenticating the client computing device and re-establishing connectivity following network interruptions. The relay module uses the temporary hostname and the tokens to establish one or more bidirectional stream connections between the client computing device and the development workstation that reflect authentication, reconnection, and transport characteristics observed in production cloud-gaming systems. The relay module further manages a lifecycle for the temporary hostname and the associated authorization, maps multiple client connections to corresponding initial server connections, and invalidates the hostname and authorization upon termination, thereby reducing stale or orphaned connections and enabling consistent, repeatable testing across varied network configurations.

Another technical advantage of the disclosed techniques over the prior art is that the disclosed techniques generate a temporary hostname from a large, randomized namespace such that the hostname is unpredictable and is not reused across different sessions associated with the same development workstation. In that regard, the temporary hostname remains valid only while the corresponding initial server connection between the development workstation and the relay module is active and is automatically invalidated when the connection terminates. Because the relay module does not require prior provisioning of hostnames for individual developers, and because the randomized hostnames are not discoverable through local DNS mechanisms, the disclosed techniques reduce the risk of unsolicited connection attempts while eliminating manual configuration and hostname management for developers.

These technical advantages provide one or more technological advancements over prior art approaches.
1. In some embodiments, a computer-implemented method for establishing communication between a local server computing device and at least one client computing device comprises: establishing an initial server connection with a relay module executing; receiving, from the relay module, a temporary hostname associated with the initial server connection; providing the temporary hostname to the at least one client computing device; receiving, from the relay module, relay connection information associated with a connection established between the at least one client computing device and the relay module using the temporary hostname; generating, based on the relay connection information, a spliced connection between the local server computing device and the at least one client computing device; and communicating with the at least one client computing device over the spliced connection.
2. The computer-implemented method of clause 1, wherein establishing the initial server connection comprises establishing a secure transport-layer connection between the local server computing device and the relay module.
3. The computer-implemented method of any of clauses 1-2, wherein the relay module generates the temporary hostname in response to establishing the initial server connection.
4. The computer-implemented method of any of clauses 1-3, wherein the temporary hostname is a randomly generated identifier that is unique to a session of the initial server connection.
5. The computer-implemented method of any of clauses 1-4, wherein providing the temporary hostname to the at least one client computing device comprises generating and displaying a quick response code that encodes the temporary hostname.
6. The computer-implemented method of any of clauses 1-5, wherein the relay connection information comprises mapping data that associates the connection established by the at least one client computing device with the initial server connection.
7. The computer-implemented method of any of clauses 1-6, wherein generating the spliced connection comprises generating a server stream connection between the local server computing device and the relay module and generating a client stream connection between the at least one client computing device and the relay module.
8. The computer-implemented method of any of clauses 1-7, wherein communicating with the at least one client computing device over the spliced connection comprises receiving controller input data from the at least one client computing device.
9. The computer-implemented method of any of clauses 1-8, wherein communicating with the at least one client computing device over the spliced connection comprises transmitting configuration data from the local server computing device to the at least one client computing device.
10. The computer-implemented method of any of clauses 1-9, wherein the relay module invalidates the temporary hostname in response to the initial server connection being terminated.
11. In some embodiments, one or more non-transitory computer readable media store instructions that, when executed by one or more processors, cause the one or more processors to establish communication between a local server computing device and at least one client computing device, by performing the operations of: establishing an initial server connection with a relay module executing; receiving, from the relay module, a temporary hostname associated with the initial server connection; providing the temporary hostname to the at least one client computing device; receiving, from the relay module, relay connection information associated with a connection established between the at least one client computing device and the relay module using the temporary hostname; generating, based on the relay connection information, a spliced connection between the local server computing device and the at least one client computing device; and communicating with the at least one client computing device over the spliced connection.
12. The one or more non-transitory computer readable media of clause 11, wherein the operations further comprise receiving, from the at least one client computing device, a request to terminate the spliced connection.
13. The one or more non-transitory computer readable media of any of clauses 11-12, wherein the operations further comprise, in response to the request to terminate the spliced connection, terminating the spliced connection and terminating the initial server connection.
14. The one or more non-transitory computer readable media of any of clauses 11-13, wherein the operations further comprise: transmitting an authorization request to the relay module; and receiving, in response to the authorization request, an authorization packet associated with the initial server connection.
15. The one or more non-transitory computer readable media of any of clauses 11-14, wherein establishing the initial server connection comprises establishing a secure transport-layer connection between the local server computing device and the relay module.
16. The one or more non-transitory computer readable media of any of clauses 11-15, wherein the relay module generates the temporary hostname in response to establishing the initial server connection.
17. The one or more non-transitory computer readable media of any of clauses 11-16, wherein the temporary hostname is a randomly generated identifier that is unique to a session of the initial server connection.
18. The one or more non-transitory computer readable media of any of clauses 11-17, wherein providing the temporary hostname to the at least one client computing device comprises generating and displaying a quick response code that encodes the temporary hostname.
19. The one or more non-transitory computer readable media of any of clauses 11-18, wherein the relay connection information comprises mapping data that associates the connection established by the at least one client computing device with the initial server connection.
20. In some embodiments, a local server computing device comprises one or more memories that include instructions, and one or more processors that are coupled to the one or more memories and that , when executing the instructions, are configured to establish communication between the local server computing device and at least one client computing device, by performing the operations of: establishing an initial server connection with a relay module executing; receiving, from the relay module, a temporary hostname associated with the initial server connection; providing the temporary hostname to the at least one client computing device; receiving, from the relay module, relay connection information associated with a connection established between the at least one client computing device and the relay module using the temporary hostname; generating, based on the relay connection information, a spliced connection between the local server computing device and the at least one client computing device; and communicating with the at least one client computing device over the spliced connection.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for establishing communication between a local server computing device and at least one client computing device, the method comprising:
establishing an initial server connection with a relay module executing;
receiving, from the relay module, a temporary hostname associated with the initial server connection;
providing the temporary hostname to the at least one client computing device;
receiving, from the relay module, relay connection information associated with a connection established between the at least one client computing device and the relay module using the temporary hostname;
generating, based on the relay connection information, a spliced connection between the local server computing device and the at least one client computing device; and
communicating with the at least one client computing device over the spliced connection.

2. The computer-implemented method of claim 1, wherein establishing the initial server connection comprises establishing a secure transport-layer connection between the local server computing device and the relay module.

3. The computer-implemented method of claim 1, wherein the relay module generates the temporary hostname in response to establishing the initial server connection.

4. The computer-implemented method of claim 1, wherein the temporary hostname is a randomly generated identifier that is unique to a session of the initial server connection.

5. The computer-implemented method of claim 1, wherein providing the temporary hostname to the at least one client computing device comprises generating and displaying a quick response code that encodes the temporary hostname.

6. The computer-implemented method of claim 1, wherein the relay connection information comprises mapping data that associates the connection established by the at least one client computing device with the initial server connection.

7. The computer-implemented method of claim 1, wherein generating the spliced connection comprises generating a server stream connection between the local server computing device and the relay module and generating a client stream connection between the at least one client computing device and the relay module.

8. The computer-implemented method of claim 1, wherein communicating with the at least one client computing device over the spliced connection comprises receiving controller input data from the at least one client computing device.

9. The computer-implemented method of claim 1, wherein communicating with the at least one client computing device over the spliced connection comprises transmitting configuration data from the local server computing device to the at least one client computing device.

10. The computer-implemented method of claim 1, wherein the relay module invalidates the temporary hostname in response to the initial server connection being terminated.

11. One or more non-transitory computer readable media storing instructions that, when executed by one or more processors, cause the one or more processors to establish communication between a local server computing device and at least one client computing device, by performing the operations of:
establishing an initial server connection with a relay module executing;
receiving, from the relay module, a temporary hostname associated with the initial server connection;
providing the temporary hostname to the at least one client computing device;
receiving, from the relay module, relay connection information associated with a connection established between the at least one client computing device and the relay module using the temporary hostname;
generating, based on the relay connection information, a spliced connection between the local server computing device and the at least one client computing device; and
communicating with the at least one client computing device over the spliced connection.

12. The one or more non-transitory computer readable media of claim 11, wherein the operations further comprise receiving, from the at least one client computing device, a request to terminate the spliced connection.

13. The one or more non-transitory computer readable media of claim 12, wherein the operations further comprise, in response to the request to terminate the spliced connection, terminating the spliced connection and terminating the initial server connection.

14. The one or more non-transitory computer readable media of claim 11, wherein the operations further comprise:
transmitting an authorization request to the relay module; and
receiving, in response to the authorization request, an authorization packet associated with the initial server connection.

15. The one or more non-transitory computer readable media of claim 11, wherein establishing the initial server connection comprises establishing a secure transport-layer connection between the local server computing device and the relay module.

16. The one or more non-transitory computer readable media of claim 11, wherein the relay module generates the temporary hostname in response to establishing the initial server connection.

17. The one or more non-transitory computer readable media of claim 11, wherein the temporary hostname is a randomly generated identifier that is unique to a session of the initial server connection.

18. The one or more non-transitory computer readable media of claim 11, wherein providing the temporary hostname to the at least one client computing device comprises generating and displaying a quick response code that encodes the temporary hostname.

19. The one or more non-transitory computer readable media of claim 11, wherein the relay connection information comprises mapping data that associates the connection established by the at least one client computing device with the initial server connection.

20. A local server computing device, comprising:
one or more memories that include instructions; and
one or more processors that are coupled to the one or more memories and, when executing the instructions, are configured to establish communication between the local server computing device and at least one client computing device, by performing the operations of:
establishing an initial server connection with a relay module executing;
receiving, from the relay module, a temporary hostname associated with the initial server connection;
providing the temporary hostname to the at least one client computing device;
receiving, from the relay module, relay connection information associated with a connection established between the at least one client computing device and the relay module using the temporary hostname;
generating, based on the relay connection information, a spliced connection between the local server computing device and the at least one client computing device; and
communicating with the at least one client computing device over the spliced connection.
